(19) United States
(12) Patent Application Publication
(10) Pub. No.: US 2025/0228406 A1
(43) Pub. Date: Jul. 17, 2025

(54) Egg Cracking Mechanism

(71) Applicant: Arjun Mehta, Fremont, CA (US)

(72) Inventor: Arjun Mehta, Fremont, CA (US)

(73) Assignee: CHEFFY INC., San Francisco, CA (US)

(21) Appl. No.: 19/025,730

(22) Filed: Jan. 16, 2025

Related U.S. Application Data
(60) Provisional application No. 63/621,556, filed on Jan. 16, 2024.

(51) Int. Cl. A47J 43/14; A47J 44/00; F16H 19/04

(52) U.S. Cl. CPC A47J 43/145; A47J 44/00; F16H 19/04

(57) ABSTRACT

Embodiments of a compact and modular egg cracking mechanism driven by an actuator are described. An egg cracking mechanism comprises a main body, upper clamp, a plurality of arms, and one or more piercing members attached to the plurality of arms. An egg is placed between the upper clamp and plurality of arms. An actuator drives the upper clamp towards the egg, causing the egg shell to be pierced by one or more piercing members. The upper clamp is then actuated further, engaging the plurality of arms, causing one or more arms to move away from the main body and separate the egg shell to release its contents. The mechanism can handle eggs of various sizes and may include optional features such as removable arms and a yolk separator. In some embodiments, the mechanism is integrated into a cooking appliance for automatic egg preparation in various applications.

### TECHNICAL FIELD

The present invention relates to a kitchen device for cracking eggs and releasing their contents.

### DESCRIPTION OF THE RELATED ART

Present egg cracking apparatus are either manual, hand-operated tools for cracking one egg at a time or industrial machines that carry eggs along a conveyor and crack dozens of eggs per minute. Manual, hand-operated tools are often difficult to use because the user must apply a lot of physical force with their hand. Such tools also require precise positioning of the egg inside the tool and fail to accommodate the full range of chicken egg sizes found in the market. As a result, these tools do not consistently crack eggs, nor do they consistently release their contents without small pieces of eggshells mixed in. As a result, these tools do not consistently crack eggs and release their contents in practical use. Furthermore, they end up being as cumbersome, if not more, than cracking and separating eggs by hand. Industrial machines, on the other hand, are extremely large, heavy, and therefore not easily moved or transported. They require separate, individually driven mechanisms for each function such as gripping, cracking or piercing, and separating eggs. As a result, these large machines are only suitable in environments that can support a large footprint and sophisticated equipment. They are not suitable for smaller scale use cases where a user may want to crack only one egg or a few eggs. Additionally, due to their hefty and complex nature, they cannot be easily integrated into compact applications, such as small appliances or robotic applications. Therefore, a need exists to have a compact, automated egg cracking mechanism that supports a wide range of eggs while also being easily integrated into other appliances or robotic tools.

### SUMMARY OF THE INVENTION

The present disclosure relates to an egg cracking mechanism that automates the process of cracking and separating the contents of one or more eggs. The mechanism includes a main body, a movable upper clamp, and a plurality of arms equipped with piercing members. The mechanism operates through three main states: a default state where the egg rests in the egg chamber, a pierced state where the upper clamp drives the egg against the piercing members, and a separated state where the arms move outward to split the eggshell and release the egg contents.

The mechanism is driven by actuating means, such as a motor and gear system, which moves the upper clamp linearly or rotationally with respect to the main body. The upper clamp includes features to align and distribute pressure evenly on the egg, preventing premature cracking and ensuring consistent performance. The arms can be equipped with optional features such as torsion springs or similar biasing mechanisms to return them to their default position after operation, as well as magnets to enhance alignment during operation.

The design includes a channel in the main body for guiding the movement of the upper clamp, gear assemblies for actuating the arms, and structural features for mounting to a cooking appliance. The mechanism can handle eggs of various sizes through adjustable features such as partially teethless gears, compliant guiding mechanisms, and sloped arms. The system is designed for integration with appliances that can automatically heat a cooking surface, crack eggs, and even separate yolks from egg whites.

Optional features include sensors for detecting the state of the mechanism, a yolk separation cup, and user interface elements such as an LCD screen and speaker for providing feedback. The disclosure provides a compact, efficient, and modular mechanism for cracking eggs that can be adaptable to various cooking applications.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a front perspective view of an exemplary embodiment of an egg cracking integrated into a cooking appliance according to the present disclosure;

FIG. 2 is a front view of an exemplary embodiment of an egg cracking mechanism in the default state, also referred to as the non-triggered state;

FIG. 3 is a partial rear view of an exemplary embodiment of an egg cracking mechanism in the default state, also referred to as the non-triggered state;

FIG. 4 is a front view of an exemplary embodiment of an egg cracking mechanism in the second state, also referred to as the pierced state;

FIG. 5 is a partial rear view of an exemplary embodiment of an egg cracking mechanism in the second state, also referred to as the pierced state;

FIG. 6 is a front view of an exemplary embodiment of an egg cracking mechanism in the third state, also referred to as the eggshell separated state;

FIG. 7 is a partial rear view of an exemplary embodiment of an egg cracking mechanism in the third state, also referred to as the eggshell separated state;

FIG. 8 is a rear perspective view of an exemplary embodiment of a main body;

FIG. 9 is a left side perspective view of an exemplary embodiment of a main body;

FIG. 10 is a front sectional view of an exemplary embodiment of a main body, viewed along the cross-sectional line 33;

FIG. 11 is a sectional view of the exemplary embodiment of an egg cracking mechanism of FIG. 1, sectioned along the plane indicated by the numeral 18, and partially exploded for ease of visualization.

FIG. 12 is a front perspective view of an exemplary embodiment of an egg cracking mechanism;

FIG. 13 is a side view of an exemplary embodiment of an egg cracking mechanism;

FIG. 14 is a partial front view of the exemplary embodiment of an egg cracking mechanism depicted in FIG. 13;

FIG. 15 is a partial rear view of the exemplary embodiment of an egg cracking mechanism depicted in FIG. 13;

FIG. 16 is a front view of the exemplary embodiment of an egg cracking mechanism depicted in FIG. 13 in the non-triggered state;

FIG. 17 is a front view of the exemplary embodiment of an egg cracking mechanism depicted in FIG. 13 in the piercing state.

### DETAILED DESCRIPTION

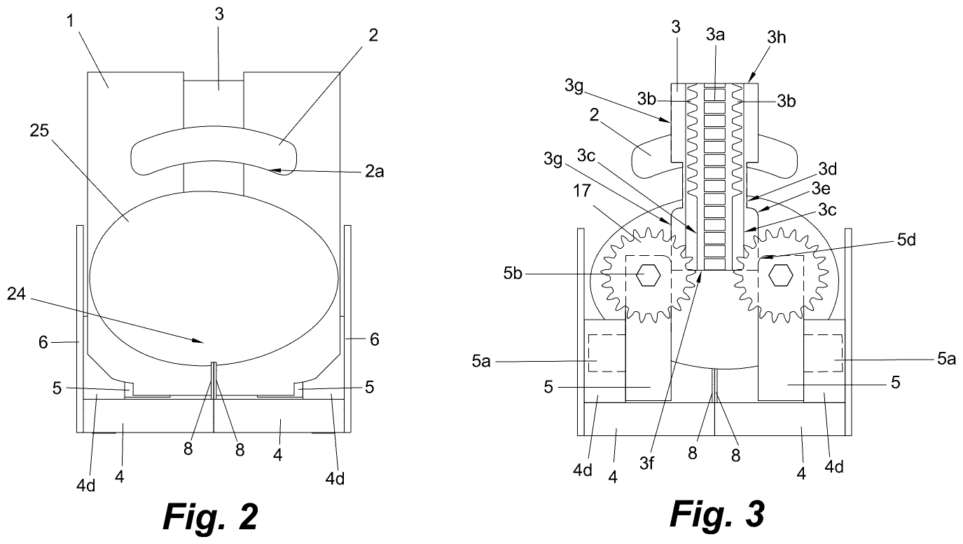

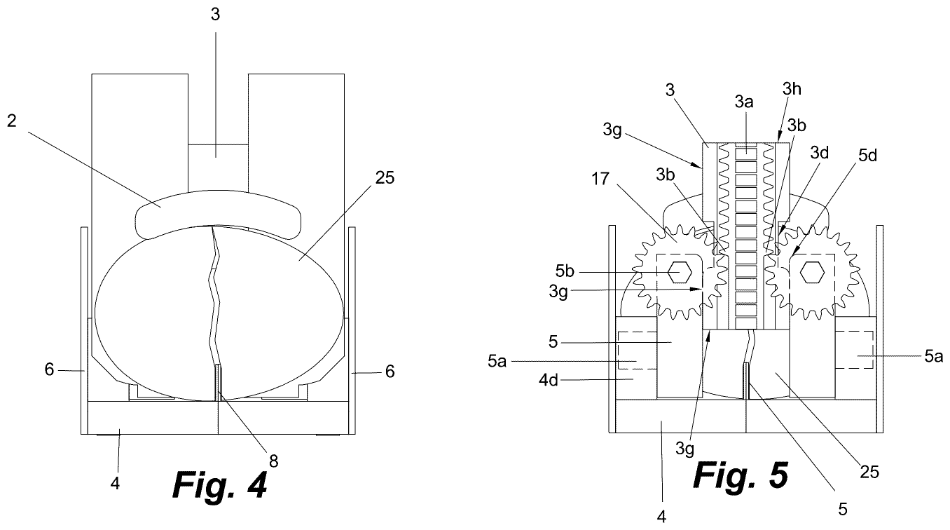

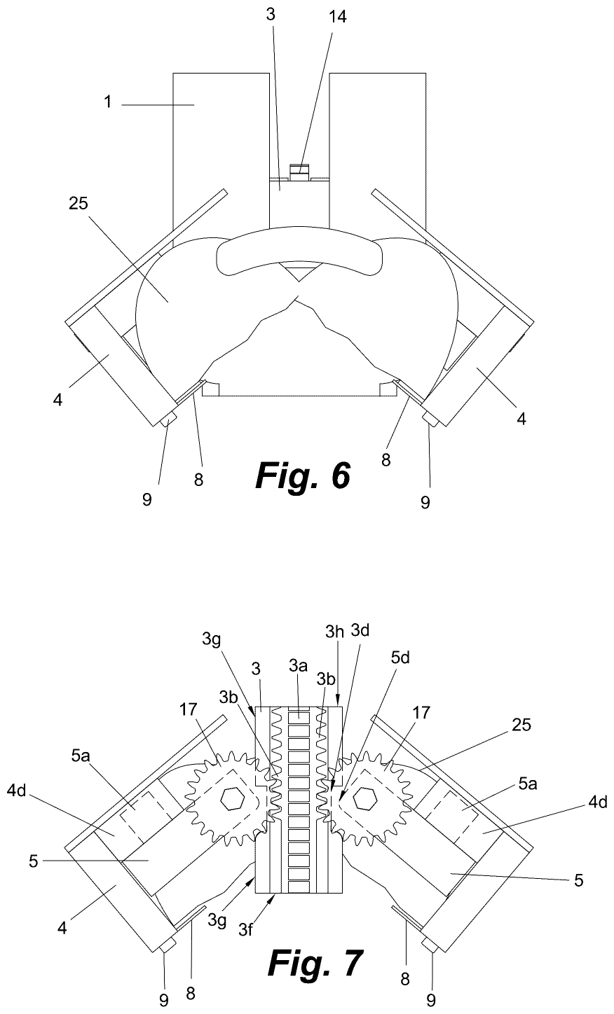

The present disclosure provides embodiments of an egg cracking mechanism, which comprises of a main body 1, upper clamp 2, and plurality of arms 4. One or more piercing members 8 is connected to one or more of the plurality of arms 4. The upper clamp 2 and at least one of the plurality of arms are moveable in relation to the main body 1. While the egg cracking mechanism is in its default state, also referred to as the non-triggered state, one or more eggs 25 may be placed in the space between the upper clamp 2 and one or more piercing members 8. This space is hereafter referred to as the egg chamber 24. An example of this default state is shown in FIGS. 2 and 3. The upper clamp 2 can be driven towards the egg 25 by actuating means 11, such as a motor, gear train, and/or both, eventually pushing the egg 25 against the one or more piercing members 8 which pierce the egg 25, marking the second state, also referred to as the pierced state, of the egg cracking mechanism. An example of this second state is shown in FIGS. 4 and 5. As the upper clamp 2 continues to move towards the egg 25, one or more levers 3b on the base 3 of the upper clamp 2 may actuate one or more of the plurality of arms 4, driving said arms 4 and therefore their respective piercing members 8 to move away from each other, thereby splitting the egg 25 and releasing its contents. The splitting of the egg 25 and releasing of its contents mark the third state, also known as the eggshell separated state, of the egg cracking mechanism. An example of this third state is shown in FIGS. 6 and 7. The upper clamp 2 may be driven back to its original position away from the egg 25, causing the one or more levers 3b to drive one or more plurality of arms 4 back to their default position.

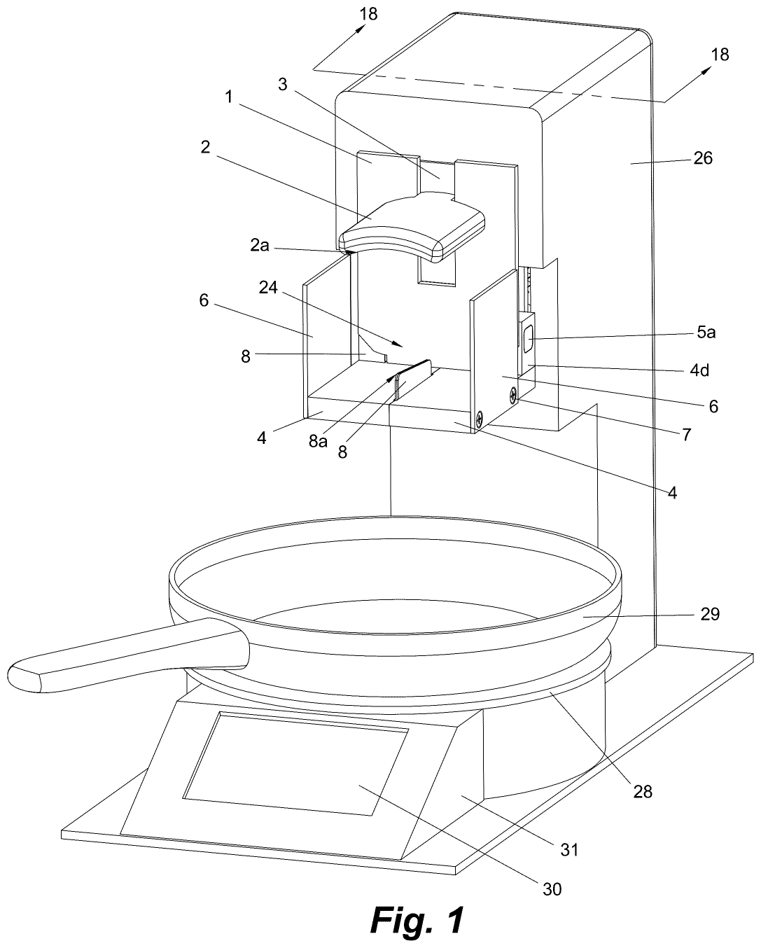

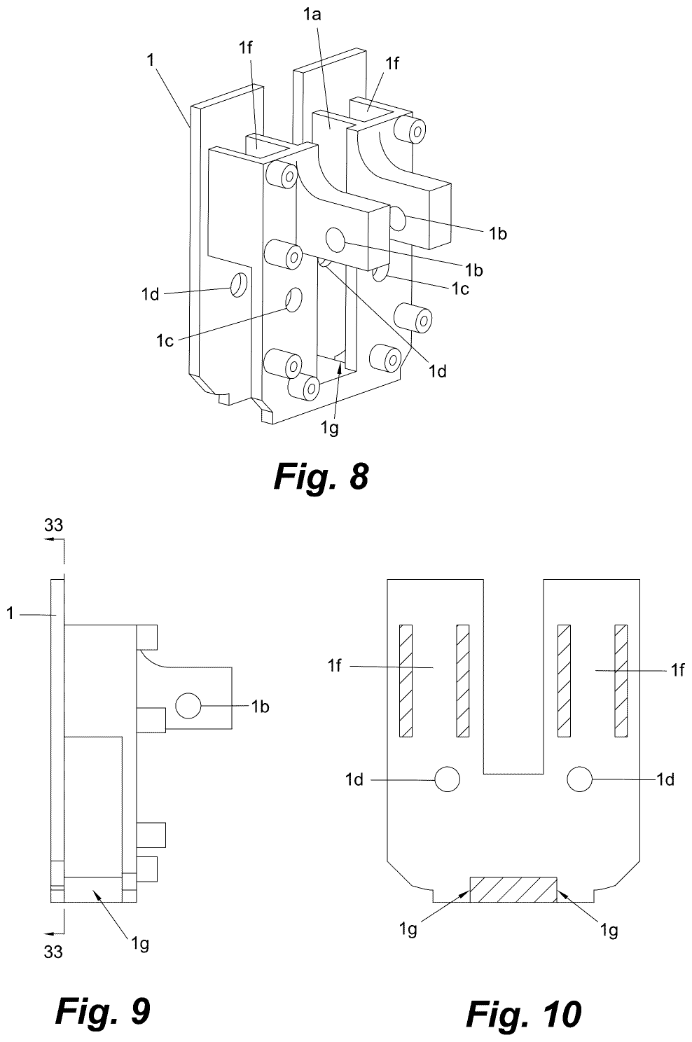

In the exemplary configurations where the main body 1 is depicted, such as FIGS. 1, 8, 9, and 10, the main body 1 may include a channel 1a within which the base 3 of the upper clamp 2 can move back and forth between its positions in the default, second, and third states. The main body 1 may also include one or more holes 1b to receive a middle gear shaft 15, allowing a middle gear 14 to be rotatably mounted onto the middle gear shaft 15, or alternatively, the middle gear 14 to be locked to the middle gear shaft 15 and the middle gear shaft 15 be rotatably mounted to the main body 1. One or more middle gear spacers 16 may be used to align the middle gear 14 in the correct position and/or to reduce axial movement. The main body 1 may also include one or more first holes 1c, each of which receives an arm shaft 19, and one or more second holes 1d, each of which also receives the corresponding arm shaft 19 to provide stabilization or alignment to each corresponding arm shaft 19. A fastening system le, such as screws, adhesive, or a press-fit configuration, may also be present to attach the main body 1 to a cooking appliance body 26, allowing the egg cracking mechanism to be incorporated into an appliance. In some embodiments, the main body 1 includes one or more recesses If to receive the leg of one or more torsion springs 22 which encourage one or more of the plurality of arms 4 to return to their default state. In some embodiments, the main body 1 includes a blocking surface 1g which prevents the plurality of arms 4 from returning to a position past their default state so that they always maintain the same starting position in the default state.

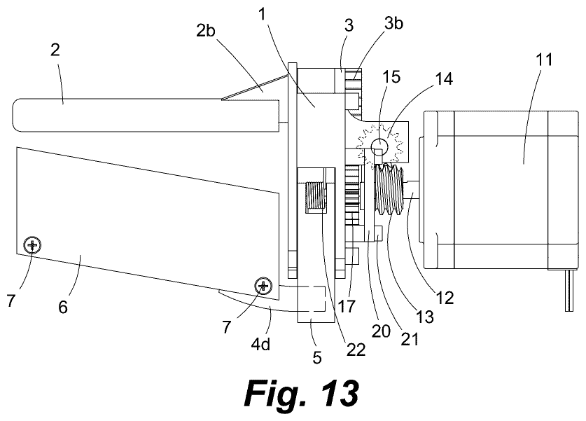

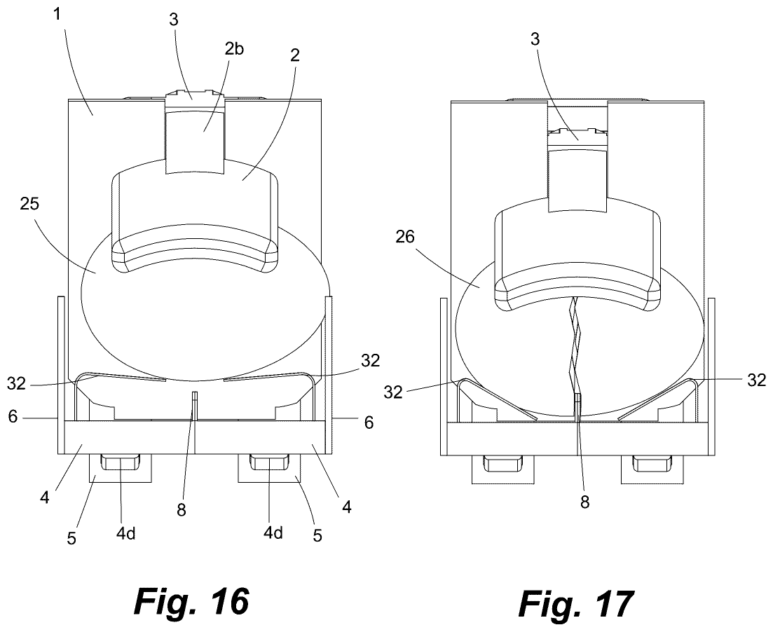

In some embodiments of the upper clamp 2, the upper clamp 2 slides linearly with respect to the main body 1. In other embodiments, the upper clamp 2 may rotate angularly with respect to the main body 1. The upper clamp 2 may also include a curved or non-flat surface 2a, such as a concave shape, which faces the egg 25, and serves to more evenly distribute pressure applied onto the egg 25 by the upper clamp 2 to prevent the egg 25 from being cracked where it meets the upper clamp 2. This ensures that the most concentrated force on the egg 25 is applied where the egg 25 contacts the one or more piercing members 8. Concentrating the force allows the one or more piercing members 8 to be blunt rather than sharp, thereby contributing to user safety. This surface 2a may also be shaped wide enough to guide the egg 25 into alignment with the upper clamp 2 and one or more piercing members 8. Aiding in correct alignment allows successful egg cracking even with imperfect positioning of the egg 25 by the user, thereby improving the success rate while also making the mechanism easier to operate. In some embodiments, such as that shown in FIGS. 13, 16, and 17, the upper clamp 2 may be elongated to accommodate pressing down on multiple eggs 25 at the same time. The upper clamp 2 may also include a reinforcement structure 2b, or be made from materials such as metal, to maintain rigidity when pressing down against one or more eggs 25.

In the exemplary configuration shown in FIGS. 3, 5, 7, and 11, the base 3 of the upper clamp 2, hereafter referred to as the upper clamp base 3, may be incorporated into the design of the upper clamp 2. In other embodiments, the upper clamp base 3 may be a separate piece that is then fastened to the upper clamp 2 via screws, a snap-fit mechanism, press-fit mechanism, overmolding, adhesive, or other joining means. In some embodiments, the upper clamp base 3 may include a middle rack gear 3a positioned to mate with the previously mentioned middle gear 14, thereby allowing rotation of the middle gear 14 to drive the upper clamp 2.

In some embodiments, the upper clamp base 3 may also include one or more levers 3b, preferably in the form of one or more rack gears 3b, hereafter referred to as side rack gears 3b, each positioned to mate with an arm gear 17. When the upper clamp base 3 moves a certain distance, each side rack gear 3b drives a mating arm gear 17, which in turn drives the plurality of arms 4 to move away from each other, causing any egg 25 in the egg chamber 24 to be split open.

In some embodiments, the one or more side rack gears 3b may feature a partially teethless surface 3c, such that the upper clamp 2 is able travel sufficiently to cause the egg 25 to get pierced by the one or more piercing members 8 before the plurality of arms 4 is actuated to move away from each other. This ensures the egg 25 is properly pierced before the plurality of arms 4 attempt to pull the egg 25 apart. Therefore, the range of motion of the upper clamp 2 may be designed such that in the non-triggered state, it sits far enough away from the one or more piercing members 8 that even jumbo sized chicken eggs can slide into the mechanism. Additionally, enough gear teeth should be removed from the side rack gears 3b such that the upper clamp 2 is able to travel enough distance to allow smaller eggs to get pierced before the plurality of arms 4 are triggered to move away from each other. By refining the dimensions of these features, the egg cracking mechanism can handle a wide range of egg sizes.

In some embodiments, the upper clamp base 3 may be designed such that a sliding surface 3g meant to slide against the channel 1a in the main body 1 may interfere with the ability of the plurality of arms 4 from rotating outward. This can be beneficial, as having the sliding surface 3g sit flush against an inward facing edge 5d of the plurality of arms 4 can help minimize wobble, backlash, or premature movement of the plurality of arms 4. On the other hand, this sliding surface 3g may also prevent the plurality of arms 4 from moving or rotating outward when the egg separation state is triggered, which would be undesired. Therefore, some embodiments of the upper clamp base 3 may include an indented surface 3d positioned such that when the upper clamp base 3 is moving between the pierced state and the egg separation state, the indented surface 3d is aligned with the inward facing edge 5d of the plurality of arms 4, allowing the plurality of arms 4 to freely move or rotate. The transition between the sliding surface 3g and indented surface 3d may include a chamfer, filleted, or partially removed portion to further reduce the likelihood of the plurality of arms' 4 movement being obstructed by the upper clamp base 3.

In some embodiments, the inward facing edge 5d of the plurality of arms 4 may also be chamfered, filleted, or partially removed, to further reduce the likelihood of the plurality of arms' 4 movement being obstructed by the upper clamp base 3 during the egg separation state.

In some embodiments, the upper clamp base 3 may have a top surface 3h and/or a bottom surface 3f intended to interact with a sensor 23, such as a limit switch or optical sensor, to allow detection of when the upper clamp base 3 has reached the end of its range of motion, which may also serve as a safety mechanism.

Next, embodiments of the plurality of arms 4, hereafter also referred to as arms 4, will be described. In some embodiments, the arms 4 are rotationally locked to a corresponding arm shaft 19 by way of a keyed hole in the arms 4 matching a corresponding keyed shape in the arm shaft 19. In other embodiments, the arms 4 may be mounted via adhesive, press-fit, or other fastening means. Similarly, each arm 4 and arm shaft 19 combination may be mounted to a corresponding arm gear 17, such as by way of a keyed hole, press-fit, adhesive, or other fastening means. In this manner, the arm gear 17 is rotationally locked to the arm shaft 19 which is in turn rotationally locked to a corresponding arm 4.

In some embodiments, the previously mentioned one or more torsion springs 22 may be mounted on each arm shaft 19, such that one leg of the torsion spring 22 sits within a pocket lf of the main body 1, and the other leg sits within a pocket 5c in each arm 4, allowing the arms 4 to be rotationally biased towards their default state. While torsion springs 22 are not required, they may aid in returning the arms 4 to their default state even when there is backlash between the arm gears 17, arm shafts 19, and/or side rack gears 3b. In embodiments where the arms 4 are linearly actuated rather than torsionally, the torsion spring 22 may be a different type of spring, such as a compression or extension spring.

In some embodiments, the arms 4 may include one or more pockets 4a to receive one or more magnets 10 so that the arms 4 are encouraged to be magnetized to each other and keep the piercing members 8 as flush against each other as possible during the default state. Ensuring the one or more piercing members 8 are flush with each other improves the success rate of piercing the egg 25 by concentrating the force onto a small area on the egg 25. The magnets 10 may also serve the purpose of preventing premature separation of the arms 4, which may sometimes be caused by a component of force against the arms 4 in the horizontal direction when the egg 25 is pressed onto the piercing members 8 by the upper clamp 2.

In some embodiments, the one or more piercing members 8 are attached to the arms 4 via a fastening system 9, which may include screws, adhesive, or other fastening means. In some embodiments, the piercing members 8 may have one or more holes 8c to receive the fastening system 9. In some embodiments, the arms 4 may include one or more pockets 4b to allow the fastening system 9, such as a screw, to recede into the arm 4, allowing the arms 4 and piercing members 8 to remain flush when in the default state. The one or more piercing members 8 may also include one or more holes or pockets 8b for the same purpose. In some embodiments, the plurality of arms 4 may include a recessed surface 4c in which a respective piercing member 8 may sit, allowing the piercing member 8 and arms 4 to both remain flush with each other in the default state.

In some embodiments, the arms 4 may be sloped to encourage the egg or eggs 25 to remain inside the egg chamber 24 instead of falling out.

In some embodiments, the arms 4 may be detachable from the mechanism, such as for easy maintenance or cleaning. In these embodiments, the design elements of the arms 4 may be separated into more than one component, such that an inner arm 5 remains inside the mechanism, while the rest of the arm 4 is jointed to an outer arm component 4d that removably mates with the inner arm 5. Each outer arm component 4d may have a mating feature, such as a protrusion or recess, to mate with a corresponding mating feature 5a on the inner arm 5. The outer arm component 4d may have a magnet 4e to aid in the alignment and/or joining of the outer arm component 4d to a corresponding inner arm 5. The corresponding inner arm 5 may also have a magnet 5e to aid in such alignment and/or joining.

In some embodiments, the arms 4 may have a fence 6 to prevent the egg 25 from falling out of the egg chamber 24. In some embodiments, the fence 6 may be completely vertical, and in others it may be a curved or non-flat shape. A fastening system 7, such as screws or adhesive, may be used to join the fence 6 to the arms 4. In other embodiments, the fence 6 may be built into the design of the arms 4.

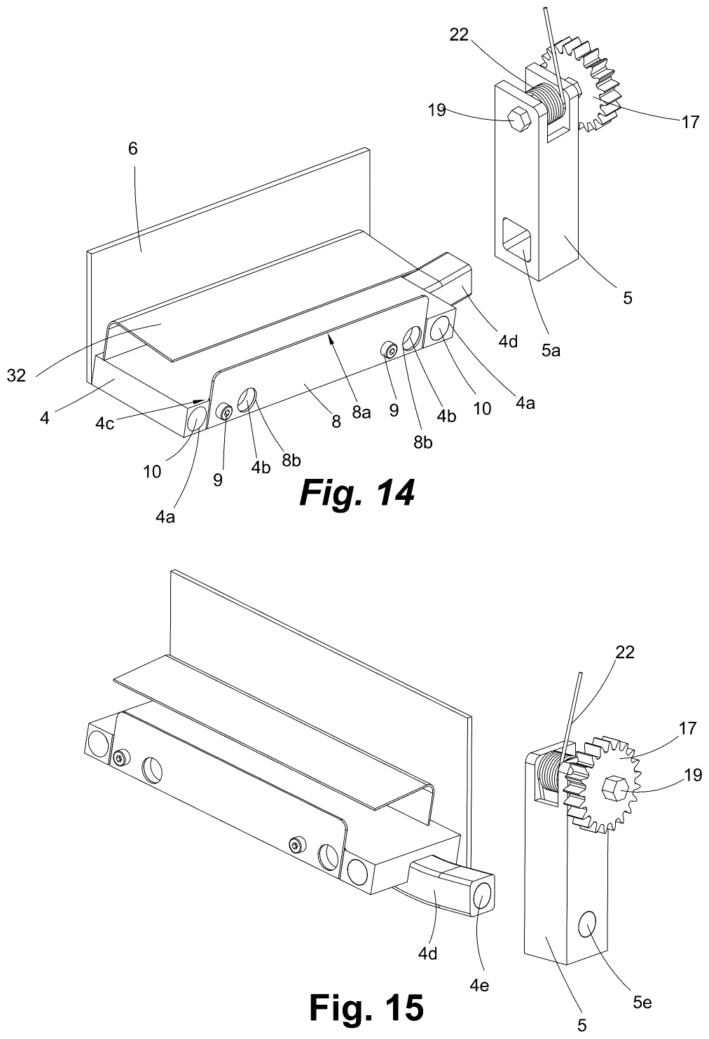

In some embodiments, the arms 4 may have a compliant mechanism 32 that facilitates better alignment of the eggs 25 within the egg chamber 24. Since the success rate of cracking the eggs 25 is greatly improved when the eggs 25 are placed horizontally into the mechanism and the center of each egg 25 sits directly above the piercing members 8, it would be beneficial to have a feature that automatically guides the egg 25 into this position, thereby making it easier to use and minimizing user error. In the example configuration shown in FIGS. 14-16, the compliant mechanism 32 comprises of a flexible material, such as spring steel or plastic, positioned above the arms 4 and sloped to encourage the egg 25 to remain centered above the one or more piercing members 8. When the egg 25 is pressed down by the upper clamp 2, the compliant mechanism 32 bends out of the way, as shown in FIG. 17, allowing the egg 25 to be pierced by the piercing member 8. When the egg cracking mechanism returns to its default state, the compliant mechanism 32 returns to its original position.

In some embodiments, the compliant mechanism 32 may be built into the design of the arms 4. In other embodiments, the compliant mechanism 32 may be attached to the arms 4 via a fastening system such as screws, press fit, adhesive, or other fastening means.

Next, embodiments of piercing members 8 shall be described. In some embodiments, the piercing edge 8a of the piercing members 8 may be blunt, and in others it may be sharpened. While a sharpened edge may allow eggs 25 to be pierced more easily with less torque from the actuating means 11, a blunt edge may improve user safety by preventing a user from accidentally cutting themselves during operation or maintenance.

In some embodiments, the piercing members 8 may be built into the arms 4, rather than exist as separate components. The piercing edge 8a may be parallel to the arms 4 or may be sloped to encourage the eggs 25 to remain inside the egg chamber 24 and prevent them from rolling out. In other embodiments, the piercing edge 8a may have one or more pointed peaks to concentrate the piercing pressure on each egg 25. The piercing members 8 may also have slots to allow egg contents to flow through and fall below the piercing member 8, rather than accumulating between the arms 4 and piercing members 8. The piercing members 8 may be made out of metal, such as steel or aluminum, or other material such as plastic, provided the material is strong enough to withstand the piercing forces.

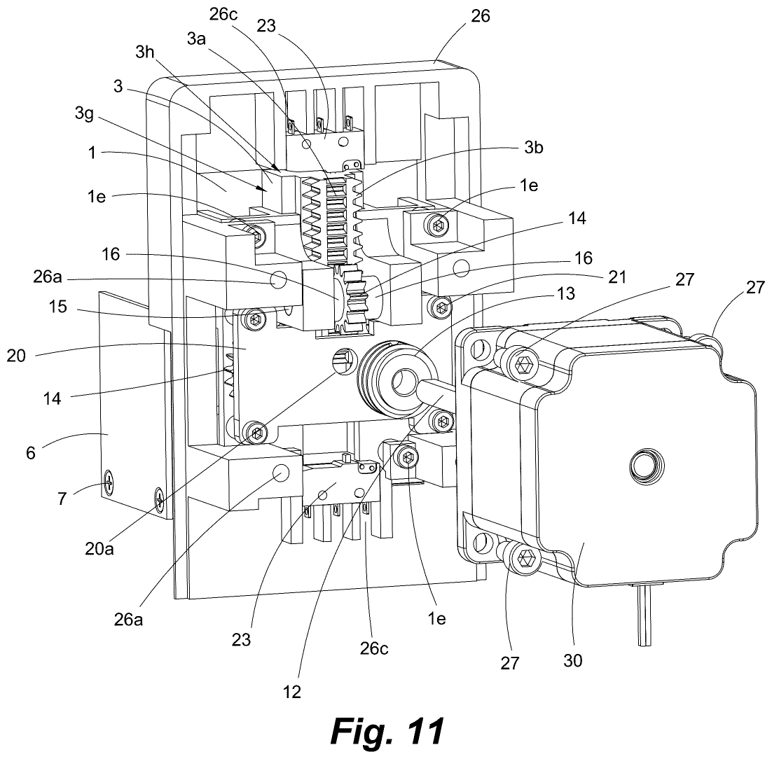

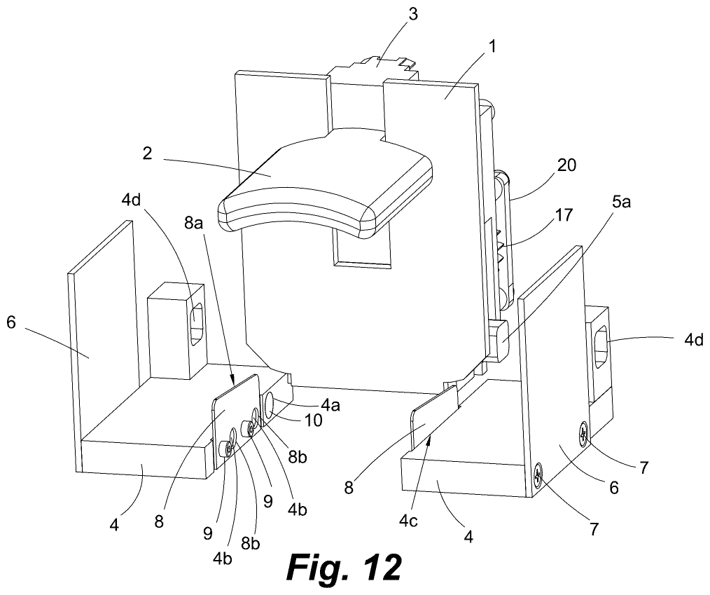

Next, turning to FIGS. 11 and 13, additional embodiments of the egg cracking mechanism shall be described. In some embodiments, the actuating means 11 may drive an actuator shaft 12. As an actuator is any device that converts energy into motion, other embodiments of the egg cracking mechanism may be driven by actuating means 11 such as but not limited to electric or gas powered motors, hydraulic systems, pneumatic systems, electromagnetic systems, and any other means of powered mechanical movement.

The actuator shaft 12 may be fastened to a worm gear 13 by fastening means such as mating keyed shapes on both actuator shaft and worm gear, press fit configuration, set screw, adhesive, and/or a combination of multiple fastening means. The worm gear 13 may be positioned such that it can drive the middle gear 14. While it is typical practice in most engineering applications to use a worm wheel with a worm gear, it is not required for the middle gear 14 to be a worm wheel in the present disclosure. Instead, a spur gear may be used, and is encouraged. While a spur gear may be technically less energy efficient than a worm wheel, a spur gear may be easier to manufacture and allows the middle rack gear 3a of the upper clamp base 3 to be of a simpler design.

In some embodiments, a gearbox back plate 20 may be attached to the main body 1 via fastening means 21, such as screws or snap fits. The gearbox back plate 20 may have a hole or recess 20a to receive the actuator shaft 12 to provide additional stability and alignment. The gearbox back plate 20 may also have one or more recesses 20b to allow a corresponding arm shaft 19 to rest inside, thereby providing additional stability and/or alignment of the arm shaft 19 and therefore arms 4. The gearbox back plate 20 may also prevent the arm gears 17 from sliding off their corresponding arm shafts 19.

In some embodiments, the egg cracking mechanism is incorporated into a cooking appliance. The cooking appliance may comprise of a cooking appliance body 26, and holes 26a to receive a fastening system le, such as screws, that affixes the main body 1 to the cooking appliance body 26. The cooking appliance body 26 may also have holes 26b to receive a fastening system 28, such as screws, to mount the actuating means 11 to the cooking appliance body 26. The cooking appliance may also comprise of one or more pockets 26c to mount one or more sensors 23, such as a limit switch or optical sensor, to aid in detecting the state or position of the egg cracking mechanism.

In some embodiments, the one or more sensors 23 may be mounted to the cooking appliance body 26 or main body 1 with a fastening system, such as screws, press fit, adhesives, snap-fits, or other fastening means.

In some embodiments, the cooking appliance may comprise of a hot plate 28, pan 29, user interface 30, temperature sensor, and/or user interface housing 31, and may allow the pan 29 to be automatically pre-heated to a set temperature and then trigger the egg cracking mechanism to crack the egg 25 and release its contents.

In some embodiments, the cooking appliance may include a microcontroller for controlling cooking time, actuation, and/or the temperature of the hot plate 28.

In some embodiments, the user interface 30 comprises an LCD screen.

In some embodiments, the cooking appliance includes a speaker to alert the user to the status of the appliance before, during, and after cooking, as well as to provide feedback while interacting with the appliance.

In an exemplary embodiment, a yolk separating cup may be placed beneath the plurality of arms 4, allowing the yolk of the egg to be caught and separated from the egg whites.

What is claimed is:

1. An egg cracking mechanism comprising:
a main body;
an upper clamp moveable relative to the main body;
a plurality of arms connected to the main body, at least one arm being moveable relative to the main body;
one or more piercing members attached to the plurality of arms;
actuating means configured to drive the upper clamp towards one or more eggs positioned between the upper clamp and the plurality of arms, thereby causing the one or more piercing members to pierce the one or more eggs; and
wherein further movement of the upper clamp engages the plurality of arms to move outwardly, separating each eggshell of the one or more eggs and release its contents.

2. The egg cracking mechanism according to claim 1, wherein:
The actuating means comprises a worm gear configured to drive a middle gear;
The middle gear is configured to engage a middle rack gear on the upper clamp;
At least one side rack side rack gear on the upper clamp is configured to drive at least one arm gear;
Each arm gear is rotationally locked to a corresponding arm shaft; and
Each arm shaft is rotationally locked to a corresponding arm from the plurality of arms.

3. The egg cracking mechanism according to claim 1, wherein the upper clamp is configured to slide linearly relative to the main body.

4. The egg cracking mechanism according to claim 1, wherein the upper clamp is configured to rotate angularly relative to the main body.

5. The egg cracking mechanism according to claim 1, wherein the upper clamp comprises a non-flat surface configured to distribute pressure evenly on one or more eggs.

6. The egg cracking mechanism according to claim 1, wherein the upper clamp includes a middle rack gear configured to engage with a middle gear, enabling movement of the upper clamp.

7. The egg cracking mechanism according to claim 1, wherein the upper clamp includes one or more side rack gears configured to engage corresponding arm gears.

8. The egg cracking mechanism according to claim 1, wherein the upper clamp comprises a partially teethless surface on the side rack gears to allow the egg to be pierced before the arms move outwardly.

9. The egg cracking mechanism according to claim 1, wherein the upper clamp comprises:
a sliding surface configured to maintain contact with the plurality of arms during specific states to minimize unintended movement; and
an indented surface configured to align with the plurality of arms during other states, enabling their rotation for separating the one or more eggs.

10. The egg cracking mechanism according to claim 1, wherein the arms include one or more magnets configured to maintain the piercing members in a flush position during the default state.

11. The egg cracking mechanism according to claim 1, wherein the arms are detachable to facilitate cleaning or maintenance.

12. The egg cracking mechanism according to claim 1, wherein the arms are biased towards a default position by one or more springs.

13. The egg cracking mechanism according to claim 1, wherein the plurality of arms are sloped to prevent an egg from falling out of the egg chamber.

14. The egg cracking mechanism according to claim 1, wherein the plurality of arms include at least one fence configured to prevent the egg from falling out of the egg chamber.

15. The egg cracking mechanism according to claim 1, wherein the piercing members include blunt edges to enhance user safety.

16. The egg cracking mechanism according to claim 1, wherein the piercing members are sloped to encourage the egg to remain in the egg chamber during operation.

17. The egg cracking mechanism according to claim 1, further comprising one or more sensors configured to detect the position or state of the upper clamp.

18. The egg cracking mechanism according to claim 1, further comprising a compliant mechanism configured to guide an egg into proper alignment with the piercing members.

19. The egg cracking mechanism according to claim 1, further comprising a yolk separator positioned beneath the plurality of arms, the yolk separator configured to separate the yolk from the egg whites after the egg is cracked.

20. An egg cracking mechanism integrated into a cooking appliance, the cooking appliance comprising:
A main body configured to hold the egg cracking mechanism; and
At least one of:
A hot plate configured to cook the contents of an egg;
A microcontroller configured to control the operation of the egg cracking mechanism;
A user interface configured to provide feedback to the user;
A temperature sensor configured to monitor the cooking environment; and/or
A sensor to detect the state of the egg cracking mechanism.
